(19) United States
(12) Patent Application Publication
(10) Pub. No.: US 2026/0024836 A1
(43) Pub. Date: Jan. 22, 2026

(54) BATTERY RETARDANTS

(71) Applicant: FORD GLOBAL TECHNOLOGIES, LLC, Dearborn, MI (US)

(72) Inventors: Michael LERNER, Corvallis, OR (US); Feng LI, Troy, MI (US); Insik JEON, Novi, MI (US); Shiran ZHANG, Ann Arbor, MI (US); Chi PAIK, Grosse Ile, MI (US)

(21) Appl. No.: 18/780,326

(22) Filed: Jul. 22, 2024

(51) Int. Cl. H01M 10/654; H01M 10/613; H01M 10/643; H01M 10/647; H01M 10/6567; H01M 10/6595; H01M 50/411

(52) U.S. Cl. CPC H01M 10/654; H01M 10/613; H01M 10/643; H01M 10/647; H01M 10/6567; H01M 10/6595; H01M 50/411

(57) ABSTRACT

A battery cell is presented. The battery cell has a negative electrode, a positive electrode, and a separator positioned between the electrodes. The separator includes a water wicking thermo-responsive organophosphate ceramic coating configured to release water as a temperature within the battery cell rises.

### TECHNICAL FIELD

The disclosure relates to retardant materials for batteries.

### BACKGROUND

Managing thermal propagation in vehicle battery packs contributes to the performance of electrified vehicle systems. Traditional strategies involve materials both inside and outside the battery cell. Internally, chemical solutions in electrolytic solutions help control thermal events. Externally, materials such as mica or aerogels are used in forms like sheets, blankets, powders/pellets, and hardening polymeric foam. However, these methods have limitations, including increased resistance and weight which may affect the efficiency of vehicle systems.

### SUMMARY

In one aspect of the disclosure a battery cell is presented. The battery cell includes a negative electrode, a positive electrode, and a separator disposed between the negative and positive electrodes. The battery cell also includes a water wicking thermo-responsive organophosphate ceramic coating configured to release water as temperature increases. The water wicking thermo-responsive organophosphate ceramic coating of the battery cell may be tricresylphosphate adsorbed onto alumina, boehmite, or Linde Type A (LTA)-/Faujasite (FAU)-type zeolite adsorbent materials. The water wicking thermo-responsive organophosphate ceramic coating of the battery cell may have an average particle size less than 1 micron. The water wicking thermo-responsive organophosphate ceramic coating of the battery cell may be dimethylmethylphosphate adsorbed onto alumina, boehmite, or LTA-/FAU-type zeolite adsorbent materials. The water wicking thermo-responsive organophosphate ceramic coating of the battery cell may be a combination of tricresylphosphate and dimethylmethylphosphate adsorbed onto alumina, boehmite, or LTA-/FAU-type zeolite adsorbent materials. The combination of tricresylphosphate and dimethylmethylphosphate in the water wicking thermo-responsive organophosphate ceramic coating of the battery cell may be in a 10:90 to 90:10 ratio. The water wicking thermo-responsive organophosphate ceramic coating of the battery cell may be coated on one side of the separator. The water wicking thermo-responsive organophosphate ceramic coating of the battery cell may be coated on more than one side of the separator. The battery cell may be a pouch cell. The battery cell may be a prismatic cell. Particles of the water wicking thermo-responsive organophosphate ceramic coating may be floating in the excess space of the prismatic cell. The battery cell may be a cylindrical cell. Particles of the water wicking thermo-responsive organophosphate ceramic coating may be floating in the excess space of the cylindrical cell.

In another aspect of the disclosure, a battery cell is presented. The battery cell includes a negative electrode, a positive electrode, a separator disposed between the negative and positive electrodes, and a water wicking thermo-responsive organophosphate ceramic coating on a surface of the negative and positive electrodes configured to release water between the negative electrode and positive electrodes as temperature increases. The water wicking thermo-responsive organophosphate ceramic coating of the battery cell may be tricresylphosphate adsorbed onto alumina, boehmite, or LTA-/FAU-type zeolite adsorbent materials. The water wicking thermo-responsive organophosphate ceramic coating of the battery cell may have an average particle size less than 1 micron. The water wicking thermo-responsive organophosphate ceramic coating of the battery cell may be dimethylmethylphosphate adsorbed onto alumina, boehmite, or LTA-/FAU-type zeolite adsorbent materials. The water wicking thermo-responsive organophosphate ceramic coating of the battery cell may be a combination of tricresylphosphate and dimethylmethylphosphate adsorbed onto alumina, boehmite, or LTA-/FAU-type zeolite adsorbent materials.

In yet another aspect of the disclosure, a battery cell is presented. The battery cell includes a negative electrode, a positive electrode, and a separator disposed between the negative and positive electrodes and including a metal oxide organophosphate coating configured to absorb phosphate during cycling of the battery cell. The metal oxide coating of the battery cell may be a mix of alumina, boehmite, or LTA-/FAU-type zeolite adsorbent materials.

### BRIEF DESCRIPTION OF THE DRAWINGS

FIG. 1 is schematic diagram of a battery cell according to one or more aspects of the disclosure;

FIG. 2 is a schematic diagram of a battery cell according to one or more aspects of the disclosure; and

FIG. 3 is a schematic diagram of a battery cell according to one or more aspects of the disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention in the context of mitigating thermal events and propagation in vehicle battery packs.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, when a composition is described as having “5 wt. % of a component,” it is to be understood as “about 5 wt. % of a component.” Furthermore, when numerical values are presented as a range, such as “100 to 200 units,” this range should be interpreted to effectively mean “about 100 to about 200 units.” Such variations are implicitly incorporated within the scope of the present disclosure to accommodate the specific requirements of incorporating phosphorus-based retardants and other-inhibiting chemicals within battery cells.

The present disclosure relates to mitigating thermal events and propagation in a vehicle battery pack by including certain materials inside the battery cell. The use of phosphorus-based retardant and inhibiting chemicals, specifically tricresylphosphate and dimethylmethylphosphonate, is proposed. These chemicals are configured to be adsorbed onto ceramic materials such as alumina (e.g., gamma-alumina), boehmite, or LTA- and FAU-type zeolite adsorbents. These adsorbent materials are incorporated into the battery cell without interfering with its normal operation. The adsorbent materials may have an average particle size no higher than one micron.

The phosphorus-based chemicals are immobilized during normal battery function but become active when the battery cell temperature exceeds 1000 Celsius. Tricresylphosphate and dimethylmethylphosphonate, when adsorbed onto the ceramic materials, have the ability to absorb phosphate during the battery's cycling process. Upon reaching an activation temperature, these materials release water, effectively mitigating thermal runaway. The adsorbent powders may be coated on either or both sides of the separator and/or on the surfaces of the anode or cathode, following the ceramic layer coating process used in standard lithium-ion cells. This strategic placement ensures that the normal operation of the battery is not affected while providing a robust mechanism to counteract thermal events.

This approach also allows for flexibility in the composition of the adsorbent materials. A mix of tricresylphosphate and dimethylmethylphosphonate in ratios ranging from 10:90 to 90:10 may be used, adsorbed, and distributed on the surfaces of alumina, boehmite, or LTA- and FAU-type zeolite adsorbents. Additionally, a mix of alumina, boehmite, or LTA- and FAU-type zeolite adsorbents supporting tricresylphosphate and dimethylmethylphosphonate in ratios from 0:100 to 100:0 may be employed. These adsorbent powders may be coated on either or both sides of the separator and/or on the anode or cathode surfaces, identical to the ceramic layer coating process. The application of these adsorbents is universal to various cell form factors, including pouch, prismatic, and cylindrical cells. In pouch or prismatic cells, the adsorbents may also be free-floating in the excess space of the cell, in addition to their locations in the separator and electrodes.

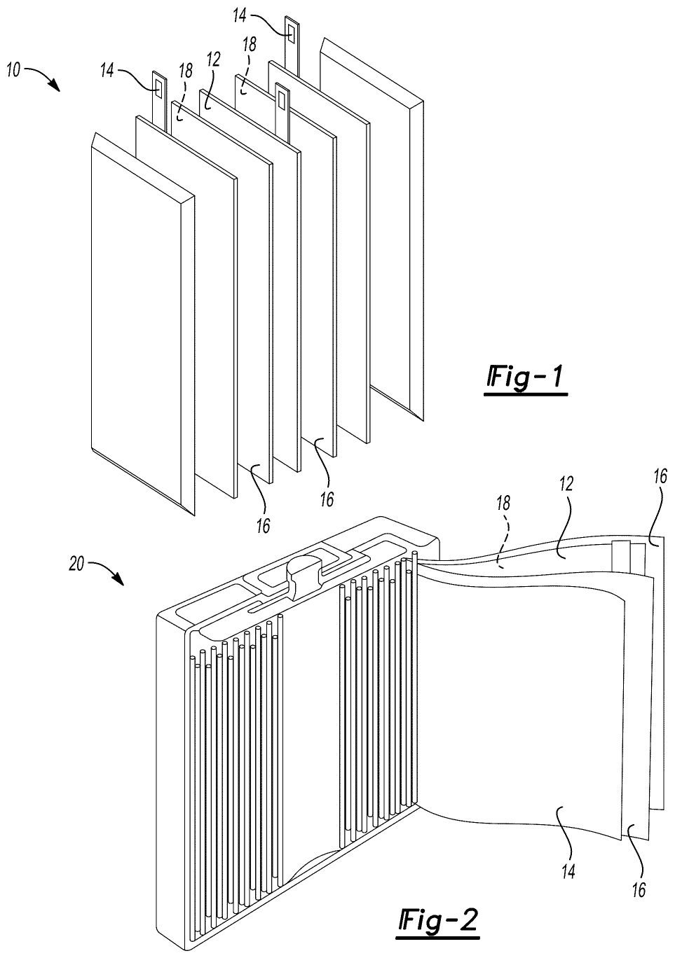

FIGS. 1-3 show schematic diagrams of battery cells according to one or more aspects of the disclosure. FIG. 1 is a pouch cell 10 with a negative electrode 12 and a positive electrode 14. The negative electrode 12 and the positive electrode 14 have a separator 16 disposed between them. The separator 16 includes a water wicking thermo-responsive organophosphate ceramic coating 18 configured to release water as temperature of the pouch cell 10 increases.

The water wicking thermo-responsive organophosphate ceramic coating 18 may be tricresylphosphate adsorbed onto alumina, boehmite, or LTA-/FAU-type zeolite adsorbent materials. The water wicking thermo-responsive organophosphate ceramic coating 18 may have an average particle size less than 1 micron. Alternatively, the water wicking thermo-responsive organophosphate ceramic coating 18 may be dimethylmethylphosphate adsorbed onto alumina, boehmite, or LTA-/FAU-type zeolite adsorbent materials.

The water wicking thermo-responsive organophosphate ceramic coating 18 may also be a combination of tricresylphosphate and dimethylmethylphosphonate adsorbed onto alumina, boehmite, or LTA-/FAU-type zeolite adsorbent materials. This combination may be in a ratio ranging from 10:90 to 90:10. The water wicking thermo-responsive organophosphate ceramic coating 18 may be applied on one side or more than one side of the separator 16. In the case of a prismatic or cylindrical cell, particles of the water wicking thermo-responsive organophosphate ceramic coating 18 may be floating in the excess space of the pouch cell 10.

FIG. 2 is a prismatic cell 20 with a negative electrode 12 and a positive electrode 14. The negative electrode 12 and the positive electrode 14 have a separator 16 disposed between them. In this configuration, the negative electrode 12 is coated with a water wicking thermo-responsive organophosphate ceramic coating 18 configured to release water as temperature increases.

The water wicking thermo-responsive organophosphate ceramic coating 18 in the prismatic cell 20 may be tricresylphosphate adsorbed onto alumina, boehmite, or LTA- and FAU-type zeolite adsorbent materials. The coating may have an average particle size less than one micron. Alternatively, the water wicking thermo-responsive organophosphate ceramic coating 18 may be dimethylmethylphosphonate adsorbed onto alumina, boehmite, or LTA- and FAU-type zeolite adsorbent materials.

The water wicking thermo-responsive organophosphate ceramic coating 18 may also be a combination of tricresylphosphate and dimethylmethylphosphonate adsorbed onto alumina, boehmite, or LTA- and FAU-type zeolite adsorbent materials in a ratio ranging from 10:90 to 90:10. The water wicking thermo-responsive organophosphate ceramic coating 18 may be applied on one side or both sides of the negative electrode 12. Additionally, particles of the water wicking thermo-responsive organophosphate ceramic coating 18 may be floating in the excess space of the prismatic cell 20, providing an additional layer of thermal protection.

Other materials that may be used for the water wicking thermo-responsive ceramic coating include triphenyl phosphate and resorcinol bis(diphenyl phosphate). These phosphorus-based retardants can be adsorbed onto similar ceramic materials, such as silica, titania, or zirconia, which also provide effective thermal management properties. These alternative materials offer versatility in the selection of retardant agents and support structures, ensuring optimized performance based on specific battery requirements.

The water wicking thermo-responsive organophosphate ceramic coating may also utilize hybrid materials combining organic and inorganic components to enhance thermal stability and mechanical strength. For instance, organophosphorus compounds can be combined with layered double hydroxides or metal-organic frameworks to create advanced composite coatings. These hybrid materials may increase the overall efficacy of thermal event mitigation by providing superior water release characteristics and structural integrity under high-temperature conditions.

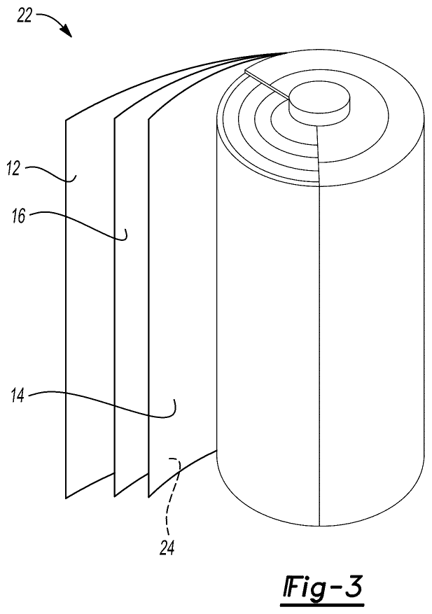

FIG. 3 is a cylindrical cell 22 with a negative electrode 12 and a positive electrode 14. The negative electrode 12 and the positive electrode 14 have a separator 16 disposed between them. In this configuration, the positive electrode 14 is coated with a metal oxide organophosphate coating 24 configured to release water as temperature increases.

The metal oxide organophosphate coating 24 in the cylindrical cell 22 may be tricresylphosphate adsorbed onto alumina, boehmite, or LTA- and FAU-type zeolite adsorbent materials. The coating may have an average particle size less than one micron. Alternatively, the metal oxide organophosphate coating 24 may be dimethylmethylphosphonate adsorbed onto alumina, boehmite, or LTA- and FAU-type zeolite adsorbent materials.

The metal oxide organophosphate coating 24 may also be a combination of tricresylphosphate and dimethylmethylphosphonate adsorbed onto alumina, boehmite, or LTA- and FAU-type zeolite adsorbent materials in a ratio ranging from 10:90 to 90:10. The metal oxide organophosphate coating 24 may be applied on one side or both sides of the positive electrode 14. Other materials that may be used for the metal oxide organophosphate coating 24 include triphenyl phosphate and resorcinol bis(diphenyl phosphate). These phosphorus-based retardants can be adsorbed onto similar ceramic materials, such as silica, titania, or zirconia, which also provide effective thermal management properties. These alternative materials offer versatility in the selection of retardant agents and support structures.

The metal oxide organophosphate coating 24 may also utilize hybrid materials combining organic and inorganic components to enhance thermal stability and mechanical strength. For instance, organophosphorus compounds may be combined with layered double hydroxides or metal-organic frameworks to create advanced composite coatings. These hybrid materials may increase the overall efficacy of thermal event mitigation by providing superior water release characteristics and structural integrity under high-temperature conditions.

While exemplary embodiments are described above, it is not intended that these embodiments encompass all possible forms covered by the claims. The words used in the specification are descriptive rather than limiting, and it is understood that various changes may be made without departing from the spirit and scope of the disclosure. The features of various embodiments may be combined to form additional embodiments of the invention that may not be explicitly described or illustrated. While certain embodiments may have been described as providing advantages or being preferred over other embodiments or prior art implementations with respect to specific desired characteristics, those skilled in the art recognize that one or more features or characteristics may be compromised to achieve desired overall system attributes, depending on the specific application and implementation. These attributes may include, but are not limited to, strength, durability, marketability, appearance, packaging, size, serviceability, weight, manufacturability, ease of assembly, and so on. Thus, embodiments described as less desirable than others with respect to one or more characteristics are not outside the scope of the disclosure and may be preferred for particular applications.

What is claimed is:

1. A battery cell comprising:
a negative electrode;
a positive electrode; and
a separator disposed between the negative electrode and positive electrode and including a water wicking thermo-responsive organophosphate ceramic coating configured to release water as temperature increases.

2. The battery cell of claim 1 wherein the water wicking thermo-responsive organophosphate ceramic coating is tricresylphosphate adsorbed onto alumina, boehmite, or LTA-/FAU-type zeolite adsorbent materials.

3. The battery cell of claim 1 wherein the water wicking thermo-responsive organophosphate ceramic coating has an average particle size less than 1 micron.

4. The battery cell of claim 1 wherein the water wicking thermo-responsive organophosphate ceramic coating is dimethylmethylphosphate adsorbed onto alumina, boehmite, or LTA-/FAU-type zeolite adsorbent materials.

5. The battery cell of claim 1 wherein the water wicking thermo-responsive organophosphate ceramic coating is tricresylphosphate and dimethylmethylphosphate adsorbed onto alumina, boehmite, or LTA-/FAU-type zeolite adsorbent materials.

6. The battery cell of claim 5 wherein tricresylphosphate and dimethylmethylphosphate are in a 10:90 to 90:10 ratio.

7. The battery cell of claim 1 wherein the water wicking thermo-responsive organophosphate ceramic coating is coated on a side of the separator.

8. The battery cell of claim 1 wherein the water wicking thermo-responsive organophosphate ceramic coating is coated on more than one side of the separator.

9. The battery cell of claim 1 wherein the battery cell is a pouch cell.

10. The battery cell of claim 1 wherein the battery cell is a prismatic cell.

11. The battery cell of claim 10 wherein particles of the water wicking thermo-responsive organophosphate ceramic coating are floating in excess space of the battery cell.

12. The battery cell of claim 1 wherein the battery cell is a cylindrical cell.

13. The battery cell of claim 12 wherein particles of the water wicking thermo-responsive organophosphate ceramic coating are floating in excess space of the battery cell.

14. A battery cell comprising:
a negative electrode;
a positive electrode;
a separator disposed between the negative electrode and positive electrode; and
a water wicking thermo-responsive organophosphate ceramic coating on a surface of the negative electrode and positive electrode configured to release water between the negative electrode and positive electrode as temperature increases.

15. The battery cell of claim 14 wherein the water wicking thermo-responsive organophosphate ceramic is tricresylphosphate adsorbed onto alumina, boehmite, or LTA-/FAU-type zeolite adsorbent materials.

16. The battery cell of claim 14 wherein the water wicking thermo-responsive organophosphate ceramic has an average particle size less than 1 micron.

17. The battery cell of claim 14 wherein the water wicking thermo-responsive organophosphate ceramic is dimethylmethylphosphate adsorbed onto alumina, boehmite, or LTA-/FAU-type zeolite adsorbent materials.

18. The battery cell of claim 14 wherein the water wicking thermo-responsive organophosphate ceramic is tricresylphosphate and dimethylmethylphosphate adsorbed onto alumina, boehmite, or LTA-/FAU-type zeolite adsorbent materials.

19. A battery cell comprising:
a negative electrode;
a positive electrode; and
a separator disposed between the negative electrode and positive electrode and including a metal oxide organophosphate coating configured to absorb phosphate during cycling of the battery cell.

20. The battery cell of claim 19 wherein the metal oxide organophosphate coating is a mix of alumina, boehmite, or LTA-/FAU-type zeolite adsorbent material.
